(19) United States
(12) Patent Application Publication
(10) Pub. No.: US 2008/0238300 A1
(43) Pub. Date: Oct. 2, 2008

(54) Organic electroluminescence device and method for fabricating the same

(76) Inventors: Sang Tae Park, Suwon-si (KR); Myung Seop Kim, Seoul (KR); Jeong Dae Seo, Incheon (KR); Jae Man Lee, Seoul (KR); Sung Hoon Pieh, Seoul (KR); Eun Soo Cha, Gwacheon-si (KR); Kyung Hoon Lee, Seoul (KR); Chang Je Sung, Seoul (KR)

Correspondence Address: KED & ASSOCIATES, LLP, P.O. Box 221200, Chantilly, VA, 20153-1200, US

(21) Appl. No.: 11/730,559

(22) Filed: Apr. 2, 2007

(51) Int. Cl. H05B 33/00; B05D 5/12

(52) U.S. Cl. 313/504; 427/64

(57) ABSTRACT

Disclosed herein are an organic electroluminescent (EL) device comprising a hole transport layer (HTL) and a method for fabricating the same. The organic electroluminescent (EL) device comprises a stack in which a light-emitting layer and a hole transport layer are interposed between an anode and a cathode, wherein the hole transport layer is made of a mixture of at least two materials, and wherein the mixture is selected from a mixture of an organic compound and one or more other organic compounds, a mixture of a metal or inorganic compound and one or more other metal or inorganic compounds, and a mixture of one or more organic compounds and one or more metal or inorganic compounds.

### BACKGROUND OF THE INVENTION

1. Field of the Invention

The present invention relates to an organic electroluminescent (EL) device. More particularly, the present invention relates to an organic electroluminescent (EL) device comprising a hole transport layer (HTL) and a method for fabricating the same.

2. Discussion of the Related Art

In general, organic electroluminescent (EL) devices consist of: an anode made of materials, e.g., indium tin oxide (ITO); a cathode made of materials, e.g., aluminum (Al); and functional organic layers sequentially stacked between the anode and the cathode. Upon application of an electric field, organic EL devices emit light. Organic EL devices have advantages in that they can be operated at a relatively low voltage and can be fabricated on flexible transparent substrates. Other advantages of organic EL devices are relatively low power consumption and light-weight.

A general method for fabricating organic EL devices will be briefly explained below.

First, as shown in FIG. 1, an anode is formed with indium tin oxide (ITO) on a glass substrate. The anode is surface-treated with plasma or UV-ozone.

A hole injection layer (HIL) is formed by depositing Copper (II) phthalocyanine (CuPc) to a thickness of about 10 to about 50 nm on the anode.

A hole transport layer is formed by depositing 4,4′-bis[N-(1-naphthyl)-N-phenylamino]-biphenyl (NPD) to a thickness of about 30 to about 60 nm on the hole injection layer.

An light-emitting layer is formed on the hole transport layer. If necessary, a dopant may be added to a material for the light-emitting layer. For green light emission, tris(8-hydroxyquinoline)aluminum (hereinafter, referred to simply to as “Alq₃”) as a material for the light-emitting layer is deposited to a thickness of about 30 to about 60 nm on the hole transport layer, and coumarin545T is used as the greed dopant.

An electron transport layer (ETL) is formed by depositing Alq₃ to a thickness of about 200 Å to about 400 Å on the light-emitting layer.

An electron injection layer (EIL) is formed by depositing LiF or Li₂O to a relatively thin thickness of about 5 Å on the electron transport layer (ETL). Alternatively, the electron injection layer (EIL) is formed by depositing an alkali metal (e.g., Li, Ca, Mg and Sm) or an alkaline earth metal to a relatively thick thickness of about 200 Å on the electron transport layer (ETL).

A cathode is formed by depositing aluminum (Al) to a thickness of about 1,000 Å on the electron injection layer (EIL).

A moisture absorbent-containing sealing cap may be attached to the cathode via a UV-hardening adhesive to protect the organic EL device from moisture or O₂ in air.

The lifetime and efficiency of the general organic EL device thus fabricated may be considerably varied depending on the kind of materials used, the structure stacked, anode surface treatment conditions, etc.

Accordingly, there has been repeated research to improve life time and efficiency of organic EL devices. However, substantially no satisfactory results have been achieved. The lifetime and efficiency of organic EL devices still remain a problem.

### SUMMARY OF THE INVENTION

Accordingly, the present invention is directed to an organic electroluminescent (EL) device and a method for fabricating the same that substantially obviate one or more problems due to limitations and disadvantages of the related art.

An object of the present invention is to provide an organic electroluminescent (EL) device having improved lifetime and efficiency via formation of a hole transport layer (HTL) using a novel material, and a method for fabricating the same.

Another object of the present invention is to provide an organic electroluminescent (EL) device realizing a simplified manufacturing process via formation of a hole transport layer (HTL) using a novel material, and a method for fabricating the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an organic electroluminescent (EL) device comprises: a stack in which a light-emitting layer and a hole transport layer are interposed between an anode and a cathode, wherein the hole transport layer is made of a mixture of at least two materials, and wherein the mixture is selected from: a mixture of an organic compound and one or more other organic compounds; a mixture of a metal or inorganic compound, and one or more other metal or inorganic compounds; and a mixture of one or more organic compounds, and one or more metal or inorganic compounds.

The hole transport layer may be made of a mixture of a first material X and a second material Y, and the first material X and the second material Y may be used in a ratio of 1:1 to 100:1 or 1:1 to 1:100.

In addition, the hole transport layer may be made of a mixture of a first material X and a plurality of other materials Y, and the first material X and the plurality of other materials Y may be used in a ratio of 1:1 to 100:1 or 1:1 to 1:100.

The hole transport layer may include at least one material having hole-blocking capability and at least one material having hole-transporting capability.

The hole-blocking material may have an oxidation potential greater than 0.4 V, and an absolute value of a highest occupied molecular orbital (HOMO) greater than or equal to 5.2 eV. The hole-blocking material may be a metal complex containing a substituted or unsubstituted 8-hydroxyquinoline and the metal is selected from aluminum (Al), zinc (Zn), magnesium (Mg) and lithium (Li).

The hole-blocking material may be a substituted or unsubstituted 1,10-phenanthroline derivative, or a substituted or unsubstituted carbazole derivative.

The hole-transporting material may have a hole mobility of 1.0×10⁻⁵ cm²/Vs or more. The hole-transporting material has an oxidation potential lower than 1.7 V and an absolute value of a highest occupied molecular orbital (HOMO) greater than or equal to 6.5 eV.

The hole-transporting material may be aromatic amine. Alternatively, the hole-transporting material may be a pyrazine derivative.

In another aspect of the present invention, there is provided a full-color organic electroluminescent (EL) device comprising a stack in which a light-emitting layer and a hole transport layer are interposed between an anode and a cathode, wherein the light-emitting layer includes at least one phosphorescent material, and the hole transport layer is made of at least one material having hole-blocking capability and at least one material having hole-transporting capability.

In another aspect of the present invention, there is provided an organic electroluminescent (EL) device comprising a plurality of light-emitting units in which a light-emitting layer and a hole transport layer are interposed between an anode and a cathode, wherein adjacent light-emitting units are separated to each other by an associated interlayer, and the hole transport layer is made of a mixture of at least one material having hole-blocking capability and at least one material having hole-transporting capability.

In yet another aspect of the present invention, there is provided a method for fabricating an organic electroluminescent (EL) device comprising: forming a first electrode on a substrate; forming a hole transport layer made of a mixture of at least one hole-blocking material and at least one hole-transporting material on the first electrode; forming a light-emitting layer including at least one phosphorescent material on the hole transport layer; and forming a second electrode on the light-emitting layer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating the structure of a general organic EL device;

FIGS. 2A to 2E are structural formulas representing hole-blocking materials used for a hole transport layer of the organic EL device according to the present invention, respectively;

FIGS. 3 to 6 are sectional view illustrating the structure of the organic EL devices according to a first to fourth embodiment of the present invention, respectively;

FIGS. 7A and 7B are graphs illustrating a comparison in IVL characteristics between two types of materials used for a hole transport layer;

FIG. 8 is a graph illustrating a comparison in lifetime between two types of materials used for a hole transport layer; and

FIGS. 9 and 10 are sectional views illustrating the structure of a phosphorescent organic EL device, in which a hole transport layer is employed.

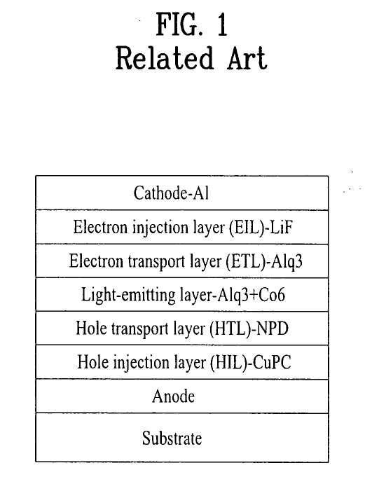

### DETAILED DESCRIPTION OF THE INVENTION

Reference will now be made in detail to the preferred embodiments of the present invention associated with an organic electroluminescent (EL) device and a method for fabricating the organic electroluminescent (EL) device according to the present invention, examples of which are illustrated in the annexed drawings.

Generally, an organic EL device emits light of a specific wavelength, via formation of excitons in a light-emitting layer, based on recombination between holes injected from an anode and electrons injected from a cathode.

Preferably, the organic EL device has a structure in which a hole transport layer (HTL) is interposed between the anode and the light-emitting layer, and an electron transport layer (ETL) is interposed between the cathode and the light-emitting layer.

This structure allows a light-emission region, where the recombination occurs, to be confined within the light-emitting layer, thus imparting high efficiency to the organic EL device.

To optimize luminous efficiency of the organic EL device, it is important to adjust a balance between electrons and holes so that carriers introduced into the light-emitting layer can be excited on the center thereof.

The optimal luminous efficiency can be achieved by controlling the thickness of the respective layers stacked, while taking into the consideration transporting capability of the hole transport layer (HTL) and the electron transport layer (ETL).

When a forward voltage is applied to an organic EL device, in a light-emitting layer, holes injected from an anode (i.e., ITO electrode) are recombined with electrons injected from a cathode to emit light.

Accordingly, Internal Quantum Efficiency of the organic EL device is obtained by the ratio of the number of protons generated inside the device to the number of charges injected from an external electrode. The Internal Quantum Efficiency (ηint) is determined by Equation 1 below:

η int= [symbol] ηr ηf (1)

wherein [symbol] represents a factor associated with a balance between electron and hole injection; ηr represents generation efficiency of singlet excitons by electron-hole recombination; and ηf represents light-emitting quantum efficiency of singlet excitons.

When recombination between electrons and holes, each having a spin S=½, induces formation of excitons in the light-emitting layer, there occurs a triplet state having S=1 in which two spins are symmetrically arranged, and a singlet state having S=0 in which two spins are anti-symmetrically arranged, in a ratio of 3:1. A ground state of most molecules is a spin singlet state.

In accordance with selection rules in quantum mechanics, singlet excitons are allowed for radiative transition to the ground state, which is referred to as “fluorescence”.

The radiative transition of triplet excitons into a singlet-ground state is preferably prohibited.

Also, triplet excitons may exceptionally undergo radiative transition by perturbation, e.g., spin-orbit coupling, which is referred to as “phosphorescence”.

In phosphorescent or fluorescent organic EL devices, the balance between electron and hole injection is maintained to obtain maximum efficiency thereof. This balance factor, [symbol] , is also called a “charge balance factor”.

In conventional organic EL devices, excessive holes are injected into the light-emitting layer, as compared to electrons.

The injection of excessive holes causes a deterioration in efficiency. In order to avoid such phenomenon, holes injected into the emitting layer need to be controlled.

Such control of holes enables a desired recombination between holes and electrons, thus improving efficiency and lifetime of the organic EL device.

The organic EL device according to one embodiment of the present invention comprises a stack in which a light-emitting layer and a hole transport layer are interposed between an anode and a cathode.

The hole transport layer is made of a mixture of at least two materials. The mixture is selected from: a mixture of an organic compound and one or more other organic compounds; a mixture of a metal or inorganic compound and one or more other metal or inorganic compounds; and a mixture of one or more organic compounds and one or more metal or inorganic compounds.

Preferably, the hole transport layer has a thickness of about 0.1 to about 500 nm.

In a case where the hole transport layer is made of a mixture of a first material (X) and a second material (Y), the first material (X) and the second material (Y) are used in a ratio of 1:1 to 100:1 or 1:1 to 1:100.

In addition, in a case where the hole transport layer is made of a mixture of a first material (X) and a plurality of other materials (Y), the first material (X) and plurality of other materials (Y) are used in a ratio of 1:1 to 100:1 or 1:1 to 1:100.

Preferably, the hole transport layer includes at least one material having hole-blocking capability, and at least one material having electron-transporting capability.

The hole-blocking material preferably has an oxidation potential greater than 0.4 V and an absolute value of the highest occupied molecular orbital (HOMO) greater than or equal to 5.2 eV.

Generally, since the absolute value of the HOMO is about 5.2 eV for a green dopant, about 5 eV for a red dopant, and more than about 5.1 eV for a blue dopant, a material having a HOMO absolute value of 5.2 eV or higher is preferably used as the hole-blocking material, thus serving to block holes and excitons generated in the light-emitting layer.

The hole-blocking material may be a metal complex containing a substituted or unsubstituted 8-hydroxyquinoline. The metal may be selected from aluminum (Al), zinc (Zn), magnesium (Mg) and lithium (Li).

Alternatively, the hole-blocking material may be a substituted or unsubstituted 1,10-phenanthroline derivative, or a substituted or unsubstituted carbazole derivative.

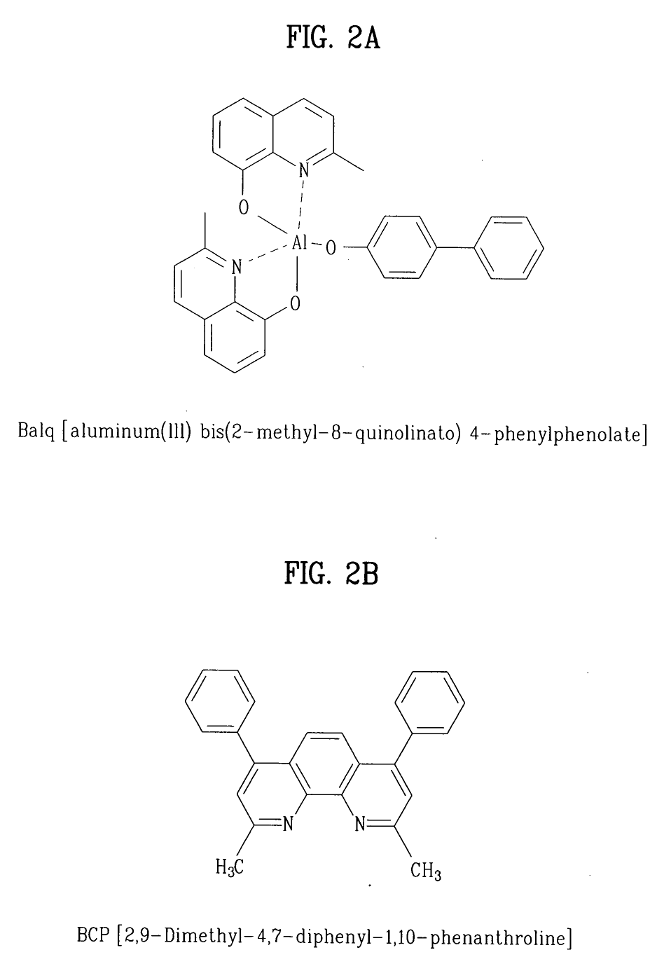

As shown in FIGS. 2A to 2E, the hole-blocking material may be selected from Balq (aluminum(III) bis(2-methyl-8-quinolinato) 4-phenylphenolate), BCP (2,9-dimethyl-4,7-diphenyl-1,10-phenanthroline), CBP [4,48-N,N8-dicarbazole-1,18-biphenyl], CF-X and CF-Y.

Preferably, the hole-transporting material has a hole mobility of 1.0×10⁻⁵ cm²/Vs or more.

The hole-transporting material preferably has an oxidation potential smaller than 1.7 V and an absolute value of the highest occupied molecular orbital (HOMO) greater than or equal to 6.5 eV.

The hole-transporting material may be aromatic amine. The aromatic amine may be a compound represented by Formula below:

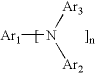

wherein n is an integer of 1 to 4; and Ar₁, Ar₂ and Ar₃ are independently a substituted or unsubstituted aromatic group.

Ar₁, Ar₂ and Ar₃ are independently selected from phenyl, naphthyl, biphenyl, biphenylelnyl, phenanthrenyl, fluorenyl, terphenylyl, and anthracenyl groups. The substituent is selected from methyl, ethyl, propyl, t-buthyl, methoxy, ethoxy, propoxy, dimethylamine, diethylamine, phenyl, fluorine, chlorine, and bromine.

The aromatic amine may be selected from compounds represented by Formulas below:

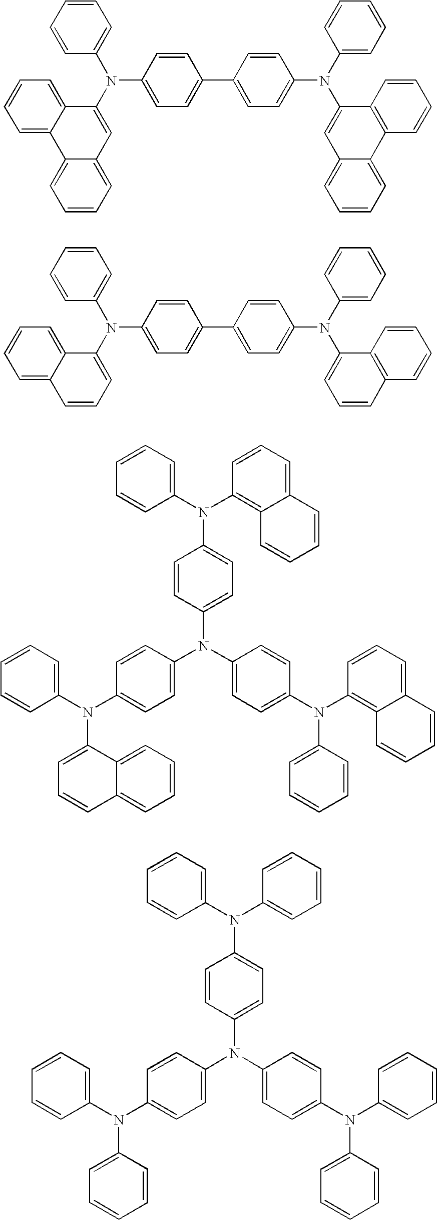

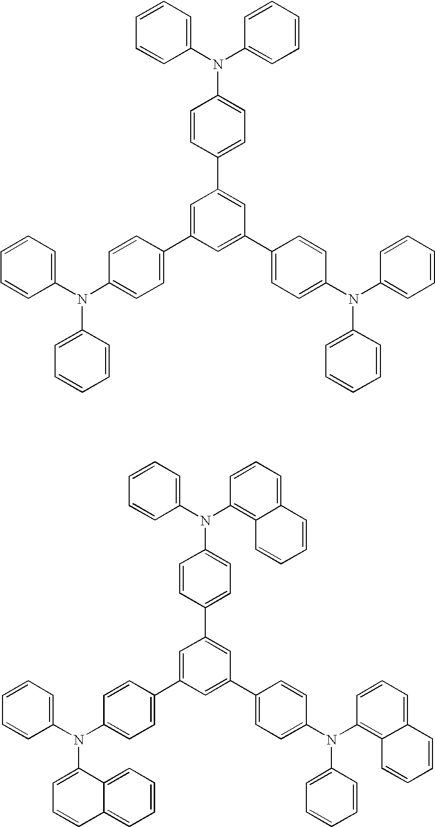

The hole-transporting material may be a pyrazine derivative.

The pyrazine derivative may be a compound represented by Formula below:

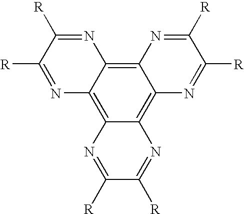

wherein each R is independently selected from a hydrogen atom, and C₁-C₁₂ halogenated hydrocarbon, alkoxy, arylamine, ester, amide, aromatic hydrocarbon, heterocyclic, nitro, and nitryl groups.

The hole transport layer serves as an exciton diffusion barrier preventing the excitons from being diffused from the light-emitting layer thereto.

The hole transport layer of the present invention can be applied to various structural organic EL devices.

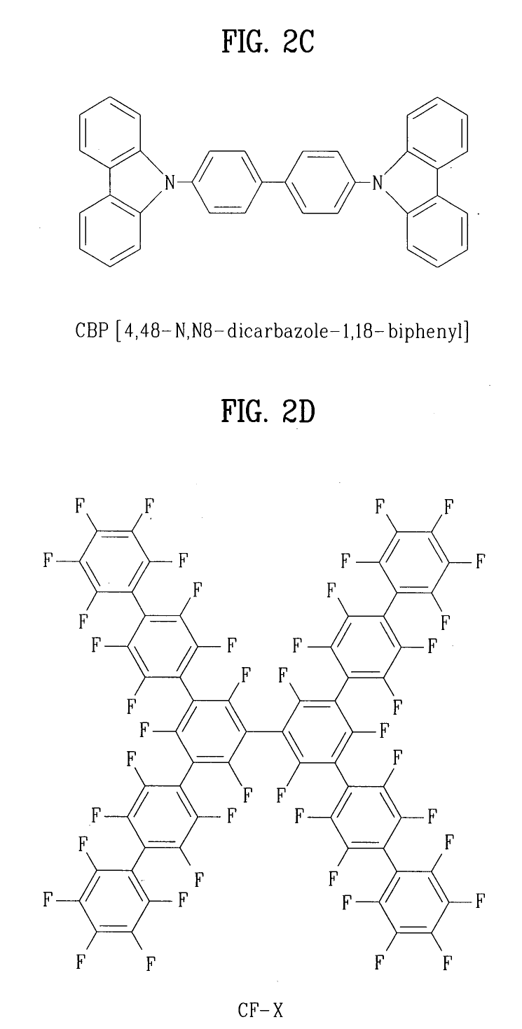

FIGS. 3 to 6 are sectional views illustrating the structure of organic EL devices according to a first to fourth embodiment of the present invention.

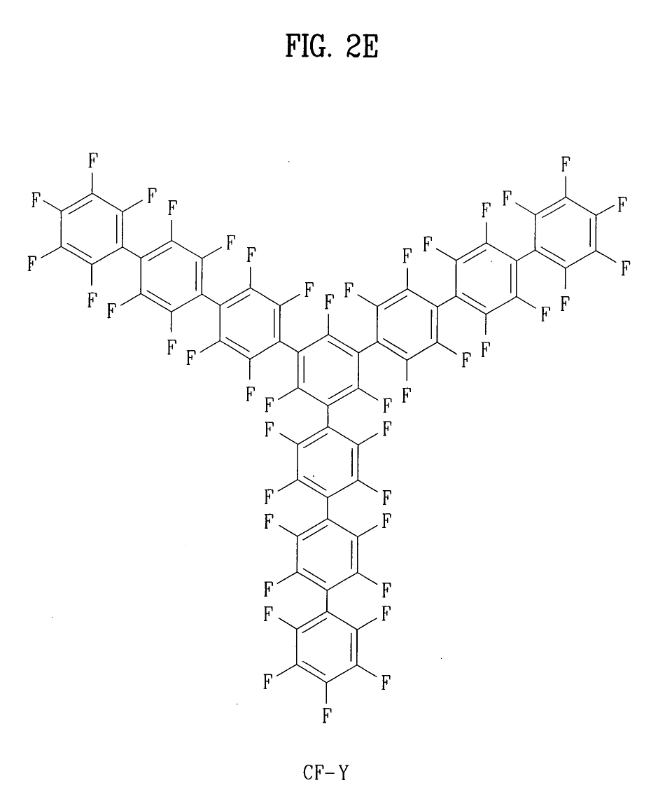

As shown in FIGS. 3 and 4, a hole transport layer may be interposed between an anode and a light-emitting layer and a hole injection layer may be interposed between the anode and the hole transport layer.

At least one of the hole transport layer and hole injection layer may be formed between the cathode and the light-emitting layer.

The light-emitting layer may include at least phosphorescent material.

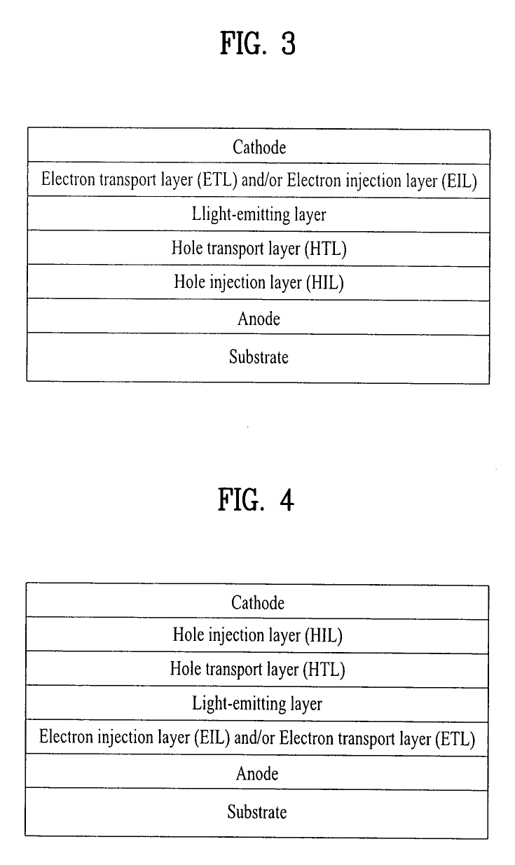

As shown in FIG. 5, the light-emitting layer may have a multilayer structure.

According to the present invention, a variety of structural organic EL devices can be fabricated.

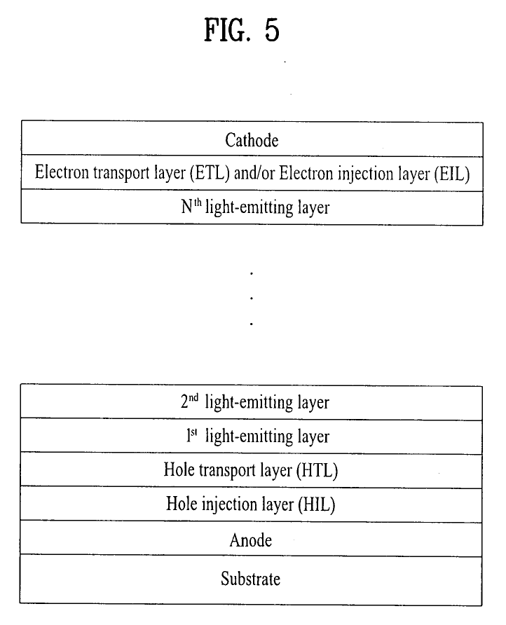

As shown in FIG. 6, a multi-type organic EL device can be fabricated.

Referring to FIG. 6, the organic EL device of the present invention comprises a plurality of light-emitting units in which the light-emitting layer and the hole transport layer are interposed between the anode and the cathode. The adjacent light-emitting units are separated to each other by an associated interlayer.

Each light-emitting unit includes the hole transport layer made of a mixture of at least one material having hole-blocking capability and at least one material having hole-transporting capability.

The light-emitting units may be same or different stack.

As shown in FIGS. 3 to 6, at least one of the anode and the cathode may be made of a transparent material.

Hereinafter, a method for fabricating the organic EL device according to the present invention will be described.

First, a first electrode is formed on a substrate. A hole transport layer made of a mixture of at least one hole-blocking material and at least one hole-transporting material is formed on the first electrode.

Next, a light-emitting layer including at least one phosphorescent material is formed on the hole transport layer.

Then, a second electrode is formed on the light-emitting layer.

As such, in a device where a phosphorescent material is contained in the light-emitting layer (i.e., a phosphorescent organic EL device), the hole transport layer performs a hole-blocking function, thus avoiding the necessity for formation of a separate hole blocking layer.

Therefore, the present invention is involved in forming the hole transport layer, without any hole blocking layer, thus having an advantage of simplified manufacturing process.

More specifically, upon fabrication of a full-color organic EL device, in a case where at least one selected from a red light-emitting layer, a green light-emitting layer and a blue light-emitting layer is a fluorescent emitting layer, and at least one of the remaining layers is a phosphorescent layer (i.e., a phosphorescent-fluorescent hybrid organic EL device), the present invention enables simplification in procedure by uniformly forming a hole transport layer which performs a hole-blocking function substantially throughout the entire phosphorescent and fluorescent emitting layers, without formation of a separate hole blocking layer on the phosphorescent emitting layers.

### EXAMPLES

The present invention will be described in more detail with reference to the following examples. These examples are provided for illustrative purposes only, and should not be construed as limiting the scope and spirit of the present invention.

### Example 1

The organic EL device according to the present invention (Device 2), where a mixture of NPD and Balq is used as a material for a hole transport layer, will be compared with a conventional organic EL device (Device 1), where NPD is used as a general material for a hole transport layer, to evaluate characteristics of the organic EL device according to the present invention thus fabricated.

Fabrication of Device 1

1) A hole injection/transport layer is formed by depositing 4,4′-bis[N-(1-naphthyl)-N-phenyl-amino]biphenyl (NPD) to a thickness of about 70 nm on an anode made of ITO.

2) For a blue light-emission device, a light-emitting layer is formed by depositing 4,4′-bis(2,2′-diphenylvinyl)-1,1′-biphenyl] (DPVBi) to a thickness of about 25 nm on the hole injection/transport layer.

3) An electron transport layer (ETL) is formed by depositing 8-hydroxyquinoline aluminum (Alq₃) to a thickness of about 35 nm on the light-emitting layer.

4) An electron injection layer (EIL) is formed by depositing LiF to a thickness of about 0.5 nm on the electron transport layer (ETL).

5) A cathode is formed by depositing aluminum (Al) to a thickness of about 150 nm on the electron injection layer (EIL).

Thus, the structure of the Device 1 thus fabricated is summarized as follows:

ITO/NPD (70 nm)/DPVBi (25 nm)/Alq₃ (35 nm)/LiF (0.5 nm)/Al (150 nm)—Device 1

Fabrication of Device 2

1) A hole injection/transport layer is formed by depositing 4,4′-bis[N-(1-naphthyl)-N-phenyl-amino]biphenyl (NPD) to a thickness of about 50 nm on an anode made of ITO.

2) A mixture (1:1, v/v %) of 4,4′-bis[N-(1-naphthyl)-N-phenyl-amino]biphenyl (NPD) and [aluminum (III) bis(2-methyl-8-quinolinato) 4-phenylphenolate](Balq) is deposited to a thickness of about 20 nm on the hole injection/transport layer.

3) For a blue light-emission device, a light-emitting layer is formed by depositing [4,4′-bis(2,2′-diphenylvinyl)-1,1′-biphenyl] (DPVBi) to a thickness of about 25 nm on the resulting structure.

4) An electron transport layer (ETL) is formed by depositing 8-hydroxyquinoline aluminum (Alq₃) to a thickness of about 35 nm on the light-emitting layer.

5) An electron injection layer (EIL) is formed by depositing LiF to a thickness of about 0.5 nm on the electron transport layer (ETL).

6) A cathode is formed by depositing aluminum (Al) to a thickness of about 150 nm on the electron injection layer (EIL).

Thus, the structure of the Device 2 thus fabricated is summarized as follows:

ITO/NPD (50 nm)/NPD:Balq (1:1, 20 nm)/DPVBi (25 nm)/Alq₃ (35 nm)/LiF (0.5 nm)/Al (150 nm)—Device 2

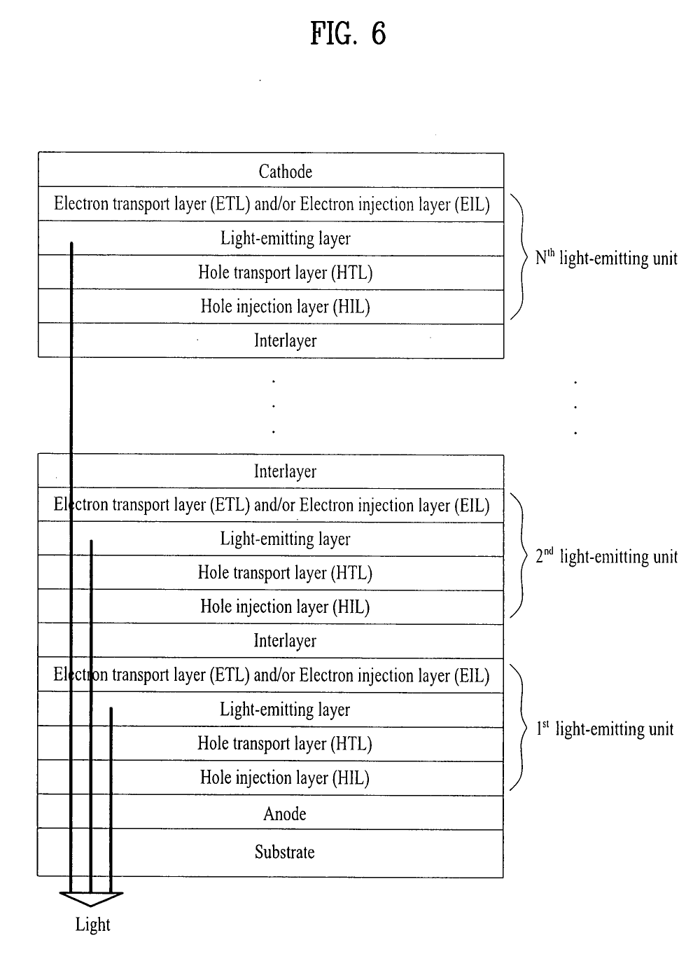

FIGS. 7A and 7B illustrate a comparison between the Device 1 and the Device 2 thus fabricated. As can be seen from the curves of FIGS. 7A and 7B, the Device 2 exhibits considerably improved current efficiency (cd/A), as compared to the Device 1.

The relatively improved luminescence efficiency of the device 2 is based on the adjustment of charge balance between holes and electrons in the emitting layer by adequately blocking a plurality of carriers, i.e., holes, introduced into the light-emitting layer.

The comparison in characteristics between two devices at a current density of 50 mA/cm² is shown in Table 1 below.

TABLE 1

| | | Volt- | Lumi- | Current | Power | Ef- |
|---|---|---|---|---|---|---|
| | | age | nance | efficiency | efficiency | ficiency |
| | HTL | (V) | (nit) | (Cd/A) | (Im/W) | (%) |
| Device 1 | NPD | 7.5 | 2,100 | 4.2 | 1.8 | Ref |
| Device 2 | NPD/Balq | 7.6 | 2,800 | 5.6 | 2.3 | 132 |
| | (1:1) | | | | | |

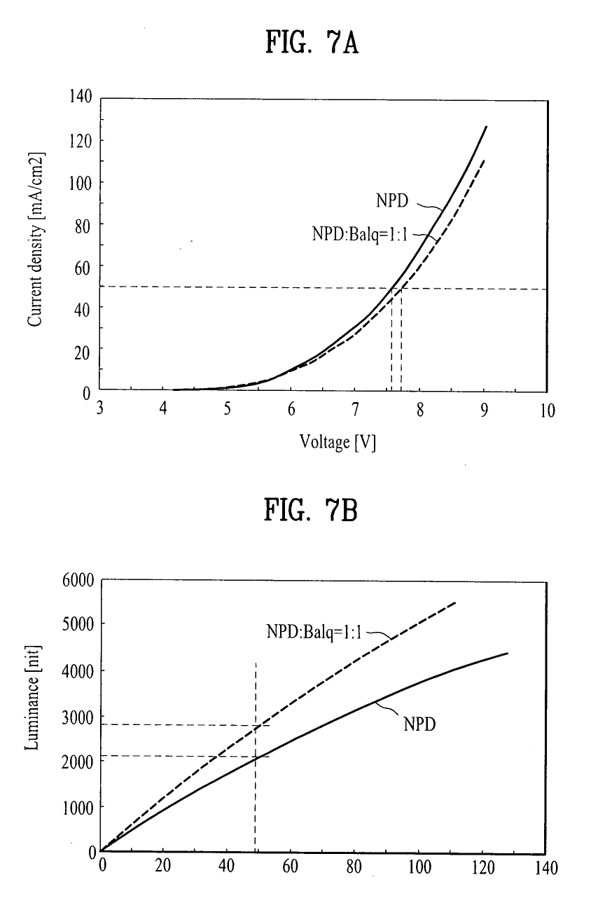

It can be confirmed from FIG. 8 that the device 2 exhibited about 160% or more prolonged lifetime, as compared to device 1.

Hereinafter, a phosphorescent organic EL device, to which the hole transport layer made of the mixture according to the present invention is applied, will be illustrated.

When recombination between electrons and holes, each having a spin S=½, induces formation of excitons in the light-emitting layer, there occurs a triplet state having S=1 in which two spins are symmetrically arranged, and a singlet state having S=0 in which two spins are asymmetrically arranged, in a ratio of 3:1. A ground state of most molecules is a spin singlet state.

In accordance with selection rules in quantum mechanics, singlet excitons are allowed for radiative transition to the ground state, which is referred to as “fluorescence”.

The radiative transition of triplet excitons into a singlet-ground state is preferably prohibited.

Also, triplet excitons may exceptionally undergo radiative transition by perturbation, e.g., spin-orbit coupling, which is referred to as “phosphorescence”.

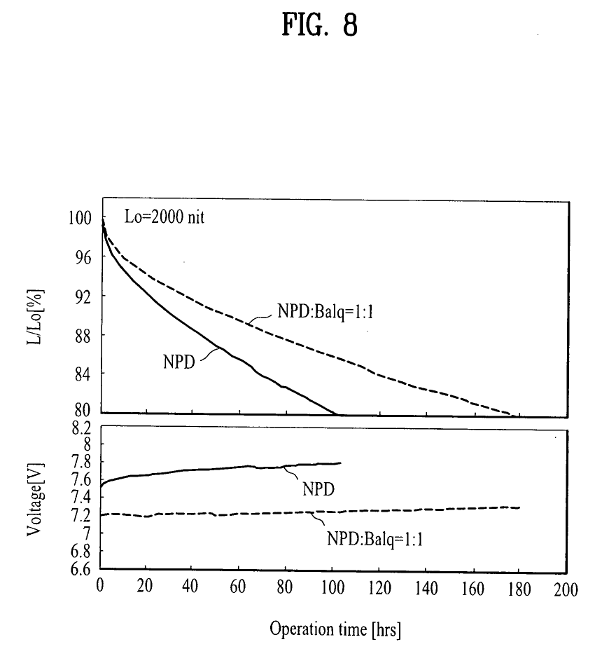

Phosphorescent devices emit light utilizing triplet excitons. In order to confine triplet excitons within the light-emitting layer such that triplet excitons formed in the light-emitting layer do not migrate to the cathode, a blocking layer (BL) is used next to the light-emitting layer, as shown in FIG. 9.

Triplet excitons diffuse into the hole transport layer and then decay, thus causing a deterioration in efficiency of the device.

For this reason, in the phosphorescent devices, it is required to prevent triplet excitons from being diffused into both the hole transport layer (HTL) and the electron transport layer (ETL).

In the case of a phosphorescent device, to which the hole transport layer (HTL) according to the present invention is applied, the phosphorescent device can exhibit maximum efficiency by confining triplet excitons within the light-emitting layer.

### Example 2

Hereinafter, the phosphorescent EL device according to the present invention (Device 4), where a mixture of NPD and Balq is used as a material for a hole transport layer, will be compared with a conventional phosphorescent EL device (Device 3), where NPD is used as a general material for a hole transport layer.

Fabrication of Device 3

1) As shown in FIG. 9, a hole injection layer (HIL) is formed by depositing copper phthalocyanine (CuPc) to a thickness of about 25 nm on an anode (ITO), as a transparent substrate.

2) A hole transport layer (HTL) is formed by depositing of 4,4′-bis[N-(1-naphthyl)-N-phenyl-amino]biphenyl (NPD) to a thickness of about 35 nm on the hole injection layer (HIL).

3) For a phosphorescent green-emission device, a light-emitting layer is formed by depositing 4,48-N,N8-dicarbazole-1,18-biphenyl (CBP), doped with about 8% tris(2-phenylpyridine)iridium [Ir(ppy)₃] to a thickness of about 25 nm on the hole transport layer (HTL).

4) A blocking layer is formed by depositing 2,9-dimethyl-4,7-diphenyl-1,10-phenanthroline (BCP) to a thickness of about 10 nm on the light-emitting layer. Then, an electron-transport layer (ETL) is formed by depositing Alq₃ to a thickness of about 25 nm on the blocking layer.

5) An electron injection layer (EIL) is formed by depositing LiF to a thickness of about 0.5 nm on the electron transport layer (ETL).

6) A cathode is formed by depositing aluminum (Al) to a thickness of about 150 nm on the electron injection layer (EIL).

Thus, the structure of the Device 3 thus fabricated is summarized as follows:

ITO/CuPC (25 nm)/NPD (35 nm)/CBP+Ir(ppy)₃ (8%) (25 nm)/BCP (10 nm)/Alq₃ (25 nm)/LiF (0.5 nm)/Al (150 nm)—Device 3

Fabrication of Device 4

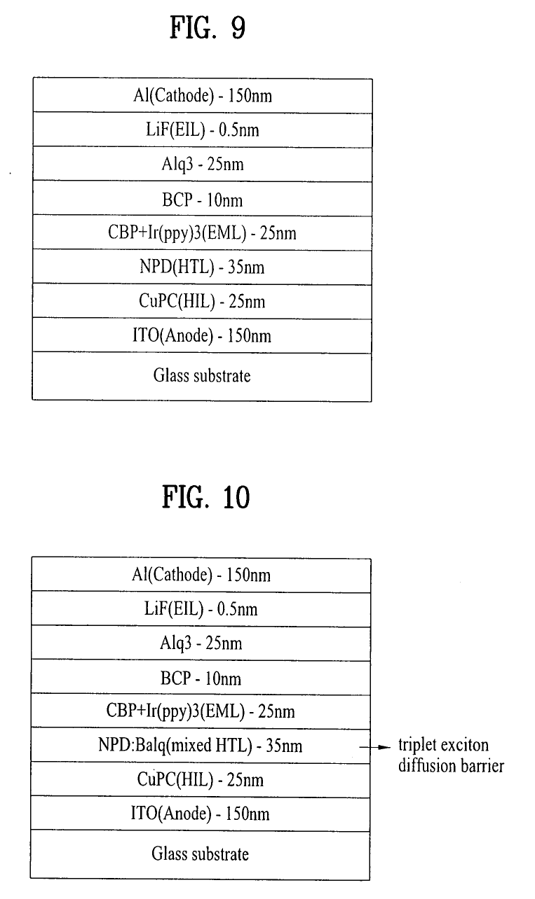

1) As shown in FIG. 10, a hole injection layer (HIL) is formed by depositing copper phthalocyanine (CuPc) to a thickness of about 25 nm on an anode (ITO), as a transparent substrate.

2) A hole transport layer (HTL) is formed by depositing a mixture (7:3, v/v %) of 4,4′-bis[N-(1-naphthyl)-N-phenyl-amino]biphenyl (NPD) and [aluminum(III) bis(2-methyl-8-quinolinato)-4-phenylphenolate] (Balq) to a thickness of about 35 nm on the hole injection layer (HIL).

3) For a phosphorescent green-emitting device, a light-emitting layer is formed by depositing 4,48-N,N8-dicarbazole-1,18-biphenyl (CBP), doped with about 8% tris(2-phenylpyridine)iridium [Ir(ppy)₃] to a thickness of about 25 nm on the hole transport layer (HTL).

4) A blocking layer is formed by depositing 2,9-dimethyl-4,7-diphenyl-1,10-phenanthroline (BCP) to a thickness of about 10 nm on the light-emitting layer. Then, an electron transport layer (ETL) is formed by depositing Alq₃ to a thickness of about 25 nm on the blocking layer.

5) An electron injection layer (EIL) is formed by depositing LiF to a thickness of about 0.5 nm on the electron transport layer (ETL).

6) A cathode is formed by depositing aluminum (Al) to a thickness of about 150 nm on the electron injection layer (EIL).

Thus, the structure of the Device 4 thus fabricated is summarized as follows:

ITO/CuPC (25 nm)/NPD:Balq (7:3, 35 nm)/CBP+Ir(ppy)₃(8%) (25 nm)/BCP (10 nm)/Alq₃ (25 nm)/LiF (0.5 nm)/Al (150 nm)—Device 4

When making a comparison between the Device 3 and the Device 4 thus fabricated, the device 4, to which the HTL made of the mixture according to the present invention is applied, exhibits high power efficiency (Im/W), as compared to the device 3, to which a HTL made of a conventional material is applied.

The comparison in characteristics between two devices at a current density of 50 mA/cm² is shown in Table 2 below.

TABLE 2

| | | Volt- | Lumi- | Current | Power | Ef- |
|---|---|---|---|---|---|---|
| | | age | nance | efficiency | efficiency | ficiency |
| | HTL | (V) | (nit) | (Cd/A) | (Im/W) | (%) |
| Device 3 | NPD | 8 | 6,407 | 25.6 | 10.1 | Ref |
| Device 4 | NPD:Balq | 8.1 | 8,300 | 33.2 | 12.9 | 128 |
| | (7:3) | | | | | |

As apparent from the foregoing, the organic EL device and the method for fabricating the same according to the present invention, a hole transport layer made of a mixture of a hole-blocking material and a hole-transporting material is employed. As a result, the lifetime and efficiency of the organic EL device can be significantly improved.

In addition, the use of the hole transport layer made of a mixture of a hole-blocking material and a hole-transporting material realizes a simplified procedure in fabrication of a phosphorescent-fluorescent hybrid organic EL device.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An organic electroluminescent (EL) device comprising a stack in which a light-emitting layer and a hole transport layer are interposed between an anode and a cathode,
wherein the hole transport layer is made of a mixture of at least two materials, and
wherein the mixture is selected from: a mixture of an organic compound and one or more other organic compounds; a mixture of a metal or inorganic compound and one or more other metal or inorganic compounds; and a mixture of one or more organic compounds and one or more metal or inorganic compounds.

2. The organic electroluminescent (EL) device according to claim 1, wherein the hole transport layer has a thickness of 0.1 to 500 nm.

3. The organic electroluminescent (EL) device according to claim 1, wherein the hole transport layer is made of a mixture of a first material X and a second material Y, and
wherein the first material X and the second material Y are used in a ratio of 1:1 to 100:1 or 1:1 to 1:100.

4. The organic electroluminescent (EL) device according to claim 1, wherein the hole transport layer is made of a mixture of a first material X and a plurality of other materials Y, and
wherein the first material X and the plurality of other materials Y are used in a ratio of 1:1 to 100:1 or 1:1 to 1:100.

5. The organic electroluminescent (EL) device according to claim 1, wherein the hole transport layer includes at least one material having hole-blocking capability and at least one material having hole-transporting capability.

6. The organic electroluminescent (EL) device according to claim 1, wherein the hole-blocking material has an oxidation potential greater than 0.4 V and an absolute value of a highest occupied molecular orbital (HOMO) greater than or equal to 5.2 eV.

7. The organic electroluminescent (EL) device according to claim 5, wherein the hole-blocking material is a metal complex containing a substituted or unsubstituted 8-hydroxyquinoline, and
wherein the metal of the metal complex is selected from aluminum (Al), zinc (Zn), magnesium (Mg) and lithium (Li).

8. The organic electroluminescent (EL) device according to claim 5, wherein the hole-blocking material is a substituted or unsubstituted 1,10-phenanthroline derivative, or a substituted or unsubstituted carbazole derivative.

9. The organic electroluminescent (EL) device according to claim 5, wherein the hole-blocking material is selected from Balq (aluminum(III) bis(2-methyl-8-quinolinato)4-phenylphenolate), BCP (2,9-dimethyl-4,7-diphenyl-1,10-phenanthroline), CBP [4,48-N,N8-dicarbazole-1,18-biphenyl], CF-X and CF-Y.

10. The organic electroluminescent (EL) device according to claim 5, wherein the hole-transporting material has a hole mobility of 1.0×10⁻⁵ cm²/Vs or more.

11. The organic electroluminescent (EL) device according to claim 5, wherein the hole-transporting material has an oxidation potential lower than 1.7 V and an absolute value of a highest occupied molecular orbital (HOMO) greater than or equal to 6.5 eV.

12. The organic electroluminescent (EL) device according to claim 5, wherein the hole-transporting material is aromatic amine.

13. The organic electroluminescent (EL) device according to claim 5, wherein the aromatic amine is a compound represented by Formula below: 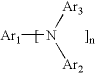
wherein n is an integer of 1 to 4; and Ar₁, Ar₂ and Ar₃ are independently a substituted or unsubstituted aromatic group.

14. The organic electroluminescent (EL) device according to claim 13, wherein Ar₁, Ar₂, and Ar₃ are independently selected from phenyl, naphthyl, biphenyl, biphenylelnyl, phenanthrenyl, fluorenyl, terphenylyl, and anthracenyl groups, and the substituent is selected from methyl, ethyl, propyl, t-buthyl, methoxy, ethoxy, propoxy, dimethylamine, diethylamine, phenyl, fluorine, chlorine, and bromine.

15. The organic electroluminescent (EL) device according to claim 12, wherein the aromatic amine is one selected from compounds represented by formulas below:

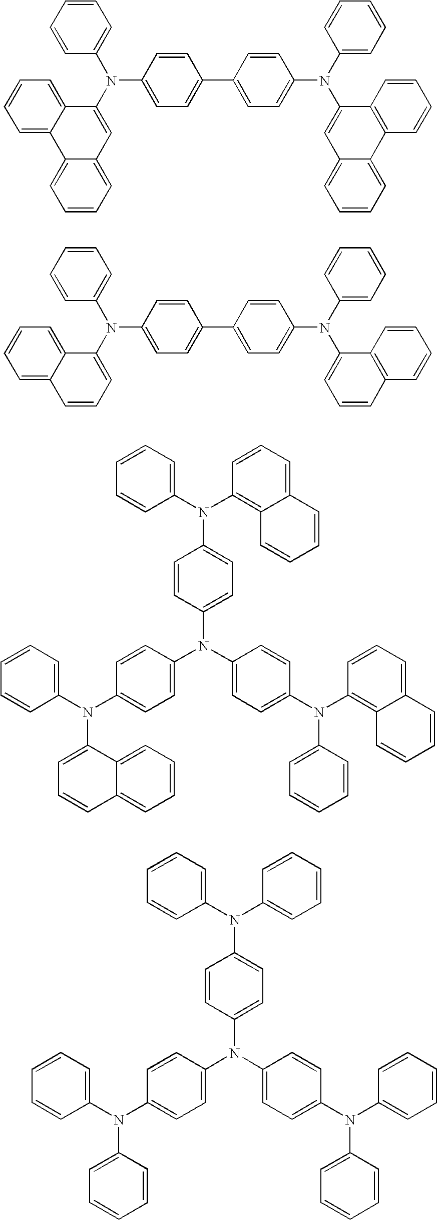

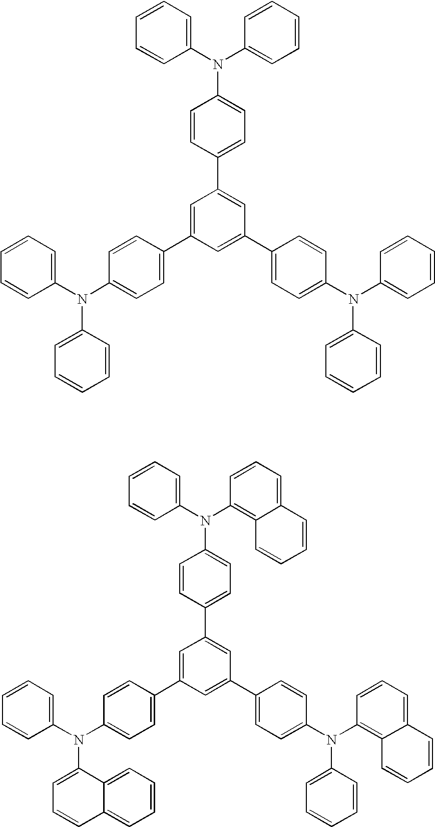

16. The organic electroluminescent (EL) device according to claim 5, wherein the hole-transporting material is a pyrazine derivative.

17. The organic electroluminescent (EL) device according to claim 16, wherein the pyrazine derivative is a compound represented by Formula below: 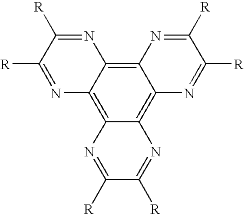
wherein each R is independently selected from a hydrogen atom, and C₁-C₁₂ halogenated hydrocarbon, alkoxy, arylamine, ester, amide, aromatic hydrocarbon, heterocyclic, nitro, and nitryl groups.

18. The organic electroluminescent (EL) device according to claim 1, wherein the hole transport layer serves as an exciton diffusion barrier preventing excitons from being diffused from the light-emitting layer to the hole transport layer.

19. The organic electroluminescent (EL) device according to claim 1, wherein at least one of an electron transport layer and an electron injection layer is interposed between the anode and the light-emitting layer.

20. The organic electroluminescent (EL) device according to claim 1, wherein a hole injection layer is interposed between the anode and the hole transport layer.

21. The organic electroluminescent (EL) device according to claim 1, wherein the light-emitting layer consists of one or more layers.

22. The organic electroluminescent (EL) device according to claim 1, wherein the light-emitting layer includes a phosphorescent material.

23. The organic electroluminescent (EL) device according to claim 1, wherein at least one of the anode and the cathode is made of a transparent material.

24. An organic electroluminescent (EL) device comprising a stack in which a light-emitting layer and a hole transport layer are interposed between an anode and a cathode,
wherein the light-emitting layer includes at least one phosphorescent material, and the hole transport layer is made of at least one material having hole-blocking capability, and at least one material having hole-transporting capability.

25. An organic electroluminescent (EL) device comprising a plurality of light-emitting units in which a light-emitting layer and a hole transport layer are interposed between an anode and a cathode,
wherein adjacent light-emitting units are separated to each other by an associated interlayer, and the hole transport layer is made of a mixture of at least one material having hole-blocking capability and at least one material having hole-transporting capability.

26. The organic electroluminescent (EL) device according to claim 25, wherein the light-emitting units are same or different stacks.

27. A method for fabricating an organic electroluminescent (EL) device comprising:
forming a first electrode on a substrate;
forming a hole transport layer made of a mixture of at least one hole-blocking material and at least one hole-transporting material on the first electrode;
forming a light-emitting layer including at least one phosphorescent material on the hole transport layer; and
forming a second electrode on the light-emitting layer.

28. The method according to claim 27, wherein the first electrode is an anode and the second electrode is a cathode.

29. The method according to claim 27, further comprising forming at least one of an electron injection layer and an electron transport layer between the second electrode and the light-emitting layer.

30. The method according to claim 27, further comprising forming a hole injection layer between the first electrode and the hole transport layer.
